(19) United States
(12) Patent Application Publication
(10) Pub. No.: US 2012/0257820 A1
(43) Pub. Date: Oct. 11, 2012

(54) IMAGE ANALYSIS TOOLS

(75) Inventors: Ashvinkumar Sanghvi, Sammamish, WA (US); Shobana Balakrishnan, Redmond, WA (US); Vishwajith Kumbalimutt, Redmond, WA (US); Anders Vinberg, Kirkland, WA (US); Srivatsan Parthasarathy, Seattle, WA (US); James Finnigan, Redmond, WA (US)

(73) Assignee: MICROSOFT CORPORATION, Redmond, WA (US)

(21) Appl. No.: 13/082,002

(22) Filed: Apr. 7, 2011

(51) Int. Cl. G06K 9/68; G06K 9/62

(52) U.S. Cl. 382/159; 382/218

(57) ABSTRACT

A master image can be generated based upon evaluation of virtual machine images. The master image includes single instances of data segments that are shared across virtual machine images within a virtual machine environment. The master image can be further be constructed as a function of a peer pressure technique that includes data segments common to a majority of the virtual machine images within the master image. The data segments included within the master image can further be defined by prioritizing data within virtual machine images as well as identifying influential data with a peer pressure technique.

### BACKGROUND

Virtual machines are software emulations of a machine, such as a computer, in which the software implementation is restricted within boundaries of the physical host computer. Conventionally, there are system virtual machines and process virtual machines. A system virtual machine emulates an entire system platform machine that includes an operating system, whereas a process virtual machine emulates a specific process. Regardless of the type of virtual machine, the emulated software is restricted to the resources provided by the virtual machine.

Generally, virtual machines enable a host computer to run multiple application environments (e.g., processes) or operating systems on the same computer simultaneously. The host computer allots a certain amount of the host's resources to each of the virtual machines in which each virtual machine uses such allotted resources to execute applications and processes (including operating systems). Typical virtual machines make use of virtual machine image files (e.g., virtual machine images) to store the desired application environment, operating system, and data related thereto. The virtual machine includes a virtual hard drive (VHD) as a typical virtual machine image. From the host's perspective, the VHD is a large file handled much like other files regardless of being associated with a virtual machine. Yet, from the virtual machine's perspective, the VHD is a full hard drive including data related to an operating system, processes, user information, and the like.

With the increase use and complexity of virtual machines, virtual machine images can become large in size (e.g., several gigabytes). Moreover, environments and hosts of virtual machines are rarely static in regards to allotted resources and storage location for images. For example, a virtual machine image may be moved from one storage location on a network to another storage location on the network. In other words, relocation of a storage location(s) for virtual machine images can be a resource intensive event based alone on the size of virtual image file size. Conventionally, the virtual machine image files are moved with lengthy and repetitive transfers, which tend to be costly in terms of system resources, among others.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to virtual machine image management. Virtual machine images can be evaluated to create a master image that includes shared data segments found in the virtual machine images. The master image can be generated based upon a peer pressure technique, offline machine learning techniques, runtime machine learning techniques, among others. For instance, the peer pressure technique can facilitate creating the master image by including common data segments found in a majority of the virtual machine image. In another example, the peer pressure technique enhances the generation of the master image by inclusion of an influential data segment identified within the virtual machine images. Further, a master image server can allow access to master images, templates to create master images, and additional virtual machine images for a larger sample set for peer pressure techniques.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a virtual machine image system.

FIG. 2 is a block diagram of a virtual machine image system that utilizes peer pressure techniques to create a master image.

FIG. 3 is a block diagram of a virtual machine image system enhanced by machine learning techniques.

FIG. 4 is a block diagram of a master image system for prioritizing data segments for a master image.

FIG. 5 is a block diagram of a system that facilitates creation and distribution of a master image.

FIG. 6 is a block diagram of a system that facilitates virtual machine image transfer based on a created master image.

FIG. 7 is a flow chart diagram of a method generating a master image from a plurality of virtual machine images.

FIG. 8 is a flow chart diagram of a method migrating virtual machine image data using a master image.

FIG. 9 is a flow chart diagram of a method accessing a server to create a master image for a plurality of virtual machine images.

FIG. 10 is a schematic block diagram illustrating a suitable operating environment for aspects of the subject disclosure.

### DETAILED DESCRIPTION

Details below are generally directed toward managing virtual machine images with a master image (e.g., golden image). Virtual machines often utilize numerous images that tend to require large amounts of storage space which make transitioning data from one location to another costly in regards to system resources. Managing these virtual machines and respective images can include migration of images, virtual machine load balancing, and virtual machine scaling. Conventional techniques often include repetitive and lengthy transfers for each virtual machine image based on the large sizes and quantities thereof. The above situation can be addressed by a master image for the virtual machine images. A master image is generated from identified segments of data that are common between the virtual machines. From these identified segments of data, a single instant of each segment of data is used to create the master image for the virtual machines. In one example, the master image includes a majority of data segments common between the virtual machine images, in order to optimize migration of images, virtual machine load balancing, and virtual machine scaling when such operations include a creation of a new virtual machine image and/or virtual machine.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

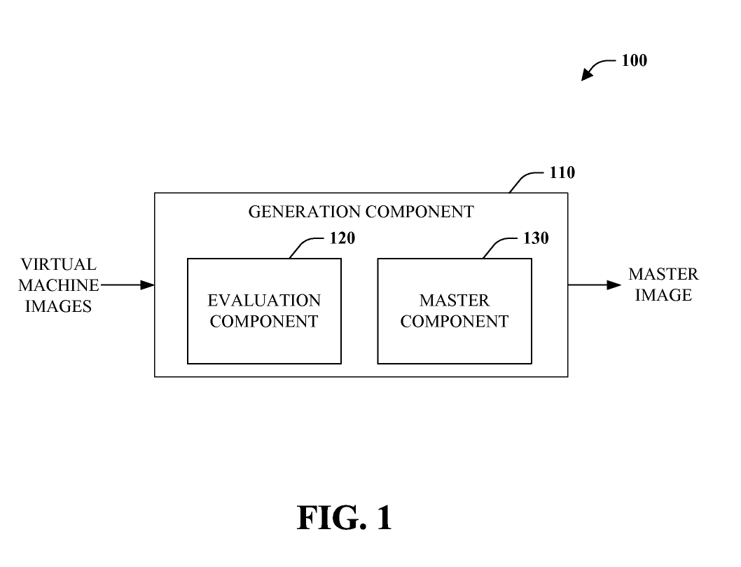

Referring initially to FIG. 1, a virtual machine image system 100 is illustrated. The virtual machine image system 100 creates a master image (e.g., also referred to as a “golden image”) that includes data segments shared between virtual machine images. In one example, the master image is generated from data segments that appear most often within the virtual machine images (discussed in more detail below). Since the master image is created with data segments that are common between the virtual machine images, creation of new or updated virtual machines and/or the virtual machine images are optimized with the master image. In general, the master image can be representative of a data-based highest common denominator for the virtual machine images and respective data, wherein the master image includes the most shared data possible for the virtual machine images. Stated differently, the master image can include the largest possible data building blocks shared between the virtual machine images.

The virtual machine image system 100 includes a generation component 110 that compares virtual machine images to create a master image. Specifically, the virtual machine image system 100 includes an evaluation component 120 that analyzes virtual machines and, in particular, virtual machine images. The evaluation component 120 can receive or collect virtual machine images from a virtual machine environment (e.g., a machine environment that includes or accesses virtual machines and virtual machine images). For example, a user can select a set or subset of virtual machine images to evaluate or selection can be automated. Upon manual or automatic selection of the virtual machine images, the evaluation component 120 compares data from each of the virtual machine images in order to identify commonalities or shared data segments. Specifically, the evaluation component 120 analyzes virtual machine images to extract common data segments from such virtual machine images.

Additionally, the virtual machine image system 100 includes a master component 130 that creates a master image (e.g., also referred to as a “golden image”) based upon the analysis of the evaluation component 120. As utilized herein, the term “master image” and “golden image” refer to a collection of data including data segments that are common between virtual machine images. Moreover, the master image can include data representative of a software program that can be executed within a virtual machine environment, and in particular, a virtual machine. It is to be appreciated that the master image can be any size (e.g., bytes, megabytes, gigabytes, etc.) and can include any type of data from any suitable source within the virtual machine environment. As stated, the master component 130 generates the master image by including a single instance of common data segments identified by the evaluation component 120. In other words, the master component 130 can monitor the identified common data segments and incorporate a single copy of each data segment into the master image. In particular, the generation component 110 and incorporated components (e.g., the evaluation component 120, the master component 130) can implement a peer pressure technique (discussed in more details below) in order to identify shared data segments in a majority of the virtual machine images.

As utilized herein, a virtual machine image includes any suitable data related to a virtual machine. By way of example and not limitation, a virtual machine image can include an operating system for a virtual machine, a process associated with a virtual machine, data related to an operating system for a virtual machine, data related to a process associated with a virtual machine, and the like. Moreover, a virtual machine image can include components/data required by all users of clients (e.g., installation files of a guest operating system, a web browser application, an antivirus application, an email application, etc.) and components specific to individual users (e.g., profiles, user specific applications, etc.). In addition, the virtual machine image can encompass data regardless of being stored on a remote virtual machine server, a local virtual hard drive (VHD), a remote VHD, a cloud-based server, a cloud-based virtual machine, a Platform as a service (PaaS) virtual machine, a PaaS VHD, a PaaS server, and the like.

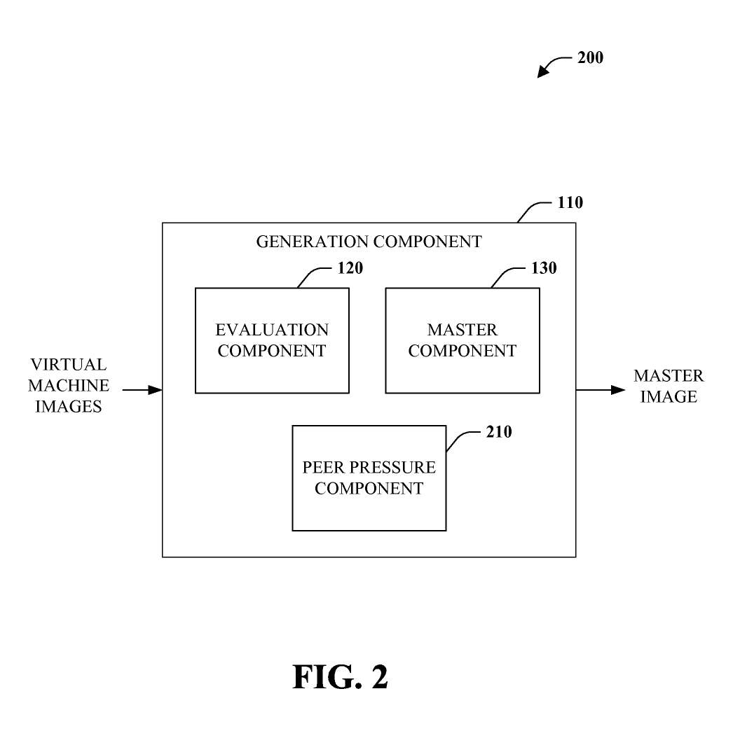

FIG. 2 illustrates a virtual machine image system 200 that utilizes peer pressure techniques to create a master image. The virtual machine image system 200 includes the generation component 110 that creates a master image for a collection of virtual machine images based upon analysis from the evaluation component 120 and/or the master component 130. It is to be appreciated that the generation component 110 can be a stand-alone component, incorporated into a virtual machine environment, incorporated into a virtual machine, incorporated into a virtual machine server, and/or any suitable combination thereof

By way of example and not limitation, a virtual machine environment may include a first group of virtual machines and a second group of virtual machines. The first group of virtual machines can be selected in which virtual machine images related thereto are evaluated in order to identify shared data segments existent between the virtual machine images (corresponding to the selected group of virtual machines). In other words, common data segments located on the virtual machine images can be collected and used to create a master image, wherein the master image includes a single instance of each common data segment. Once generated, the master image can be employed for migration of at least one of the virtual machines and/or virtual machine images within the first group (selected group of virtual machines). Moreover, the master image can be employed in the establishment of a new or updated virtual machine and/or virtual machine image.

The virtual machine image system 200 further includes a peer pressure component 210 that incorporates a peer pressure technique to facilitate creating a master image for a set of virtual machine images. As utilized herein, a peer pressure technique relates to any statistical analysis based on calculating a majority from a sample set and converging to a value or data that is identified as the majority. In other words, the peer pressure technique can provide a “power in numbers” analysis to identify shared data segments that exist within a majority or most of the virtual machine images. In another example, the peer pressure technique can relate to any statistical analysis to identify an influential data segment within the set of virtual machine images. In other words, the peer pressure technique can provide a “bully mentality” analysis to identify influential and high priority data segments that exist within the virtual machine images. In general, the system 200 can employ any suitable statistical peer pressure technique with the peer pressure component 210 in which the peer pressure technique enhances the master image by including the common data segments found within a majority of the virtual machine images or found to have an influence within the virtual machine images.

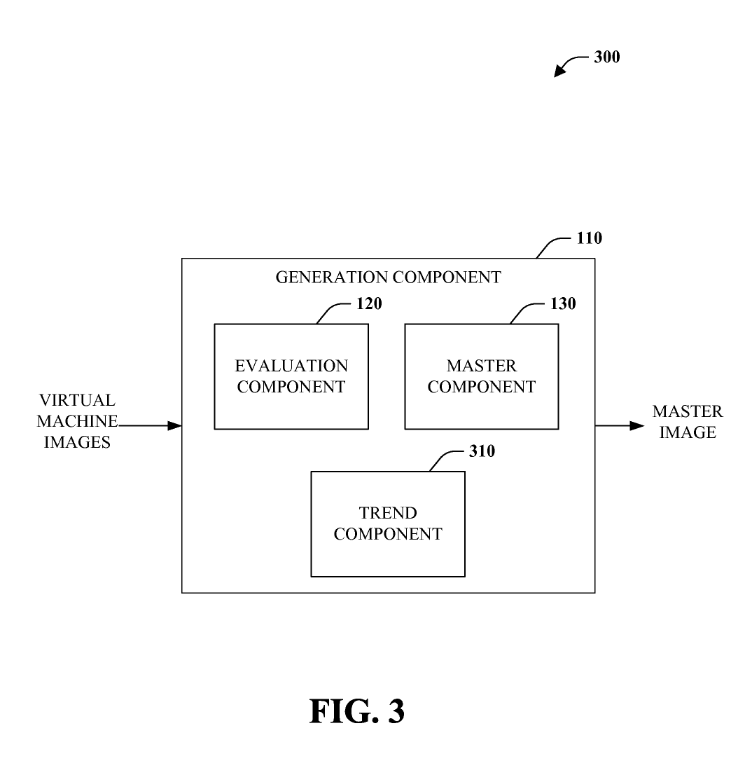

FIG. 3 illustrates a virtual machine image system 300 that is enhanced with machine learning techniques. The virtual machine image system 300 includes the generation component 110 that builds a master image from a set of evaluated virtual machine images in which the master image includes data segments existent in the virtual machine images. As discussed, the evaluation component 120 analyzes virtual machine images in order to identify common data segments that are consistent or stored on the virtual machine images. In the case where a peer pressure technique is employed, the master image includes common data segments that are consistent or stored on a high percentage (e.g., more than half) of the virtual machine images. Moreover, the master component 130 collects the common data segments and constructs a master image having a single instance of each data segment found to be common in the virtual machine images.

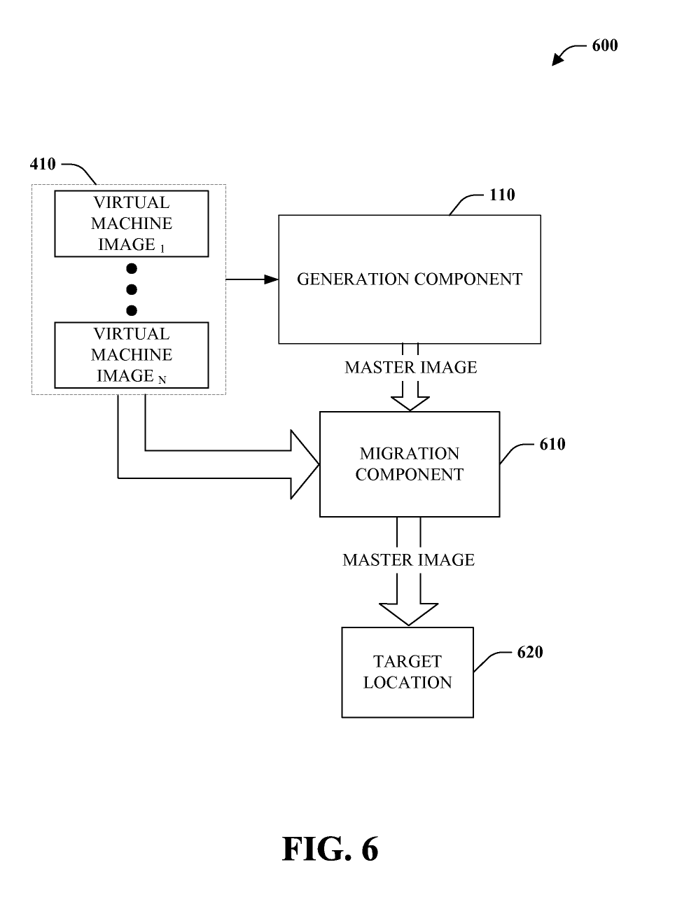

The generation component 110 can further include a trend component 310 that implements machine learning techniques in order to ascertain common data segments to include within a master image. Additionally, the trend component 310 facilitates migrating and creating virtual machines and/or virtual machine images (migration is discussed in more detail in FIG. 6). In general, the trend component 310 employs offline machine learning techniques and/or runtime machine learning techniques. By way of example and not limitation, the trend component 310 can utilize a first set of machine learning techniques offline and subsequently a second set of machine learning techniques during runtime, wherein the second set of runtime machine learning techniques can update, modify, and/or fine tune the first set of machine learning techniques. For example, the trend component 310 can employ profiling of sample sets of information or small pieces of information in addition to an offline analysis. In other words, the trend component 310 provides a two-tier machine learning technique in which offline machine learning technique(s) are enhanced by runtime machine learning technique(s).

For instance, the trend component 310 and implemented machine learning techniques (e.g., offline and/or during runtime) can identify capacity or size of a virtual machine and/or virtual machine image. Based on the capacity or size of virtual machines and/or virtual machine images, the trend component 310 can ascertain a data size for a master image. By way of example and not limitation, a master image size can be identified based upon trend component 310 analysis (e.g., offline and/or during runtime). In another example, the trend component 310 can provide course level analysis, Operating System for Monitoring (OSM) details and application level settings (e.g., based upon known application details).

In still another example, the trend component 310 can employ machine learning to extract data from memory to facilitate identifying common data segments amongst virtual machine images, migrating virtual machine images, and creating new or updated virtual machines. From memory, the trend component 310 can analyze memory objects to identify security vulnerabilities. By way of example and not limitation, the identified security vulnerabilities can be a factor for migrating virtual machines and/or virtual machine images. Moreover, such security vulnerabilities and related data segments can be excluded from inclusion in a master image. Additionally, the trend component 310 can further employ time series analysis, model predicting, virtual machine capacity prediction, or the like.

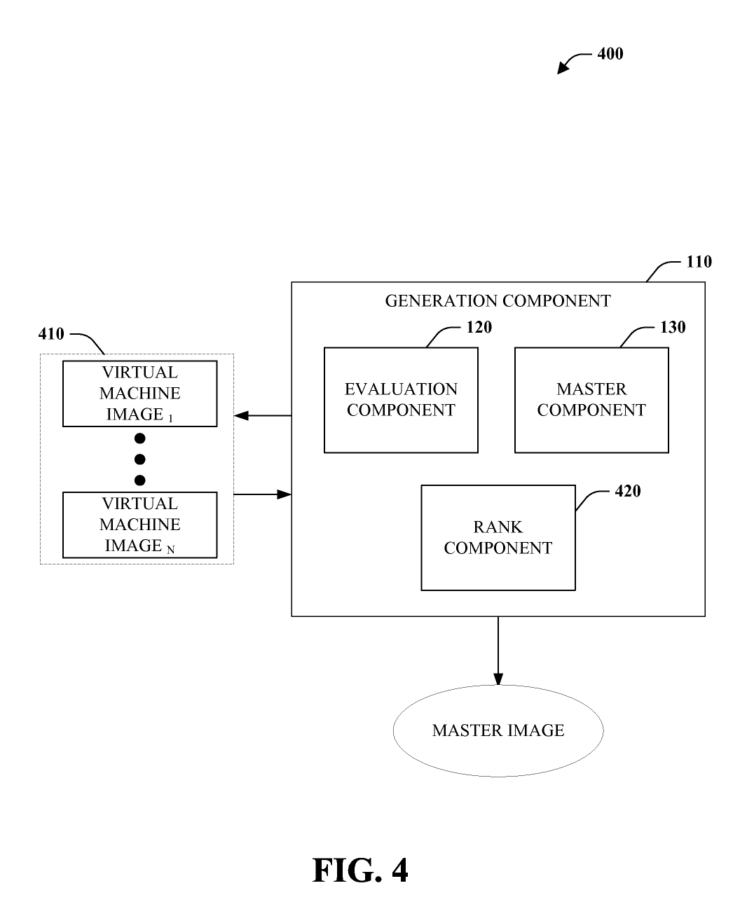

FIG. 4 illustrates a master image system 400 for prioritizing data segments for a master image. The master image system 400 includes the generation component 110 that creates a master image based upon evaluation of a plurality of virtual machine images. In particular, as discussed, the evaluation component 120 analyzes a group of virtual machine images 410, wherein there can be any suitable number of virtual machine images such as virtual machine image₁ to virtual machine image_{N}, where N is a positive integer. In combination with the evaluation component 120, the master component 130 creates a master image in order to include single instances of data segments that are common amongst the group of virtual machine images 410.

The master image system 400 can include a rank component 402 that allows identified common data segments to be prioritized, wherein a higher priority can translate into a higher probability of inclusion with a master image. Conversely, a lower priority can translate into a higher probability of exclusion with a master image. The rank component 420 can receive priority data related to specific traits, characteristics, and/or metrics in which such data can be prioritized or de-prioritized. By way of example and not limitation, data segments associated with user profiles can be set as a higher priority than application data segments. In such example, user profile data segments that are common between the virtual machine images will be prioritized to be included in a master image over the application common data segments (as well as other data segments ranked lower than the user profile data segments).

The rank component 420 enables any data segment to be prioritized based on various characteristics. The data segments can be prioritized by the rank component 420 based upon characteristics such as, but not limited to, host virtual machine (e.g., which virtual machine is hosting the data segments), size on virtual machine image, size on VHD, percentage of commonality (e.g., how often the data segment occurs within the virtual machine images), data segment type (e.g., operating system data, user profile data, application data, etc.), host virtual machine location (e.g., local, remote, cloud-based, PaaS-based, etc.), process-based (e.g., application A data segments have priority over application B since application A is security application), operating system association (e.g., prioritize operating system data segments over other data segments), user-preference, and the like. It is to be appreciated that the rank component 420 can be a factor (e.g., not the sole factor) in constructing the master image with data segments. In other words, by way of example and not limitation, the rank component 420 enables a probability to increase for a data segment to be included in a generated master image. Yet, it is to be appreciated that the rank component 420 can be configured to enable a data segment to be prioritized to automatically be included in the master image for a set of virtual machine images.

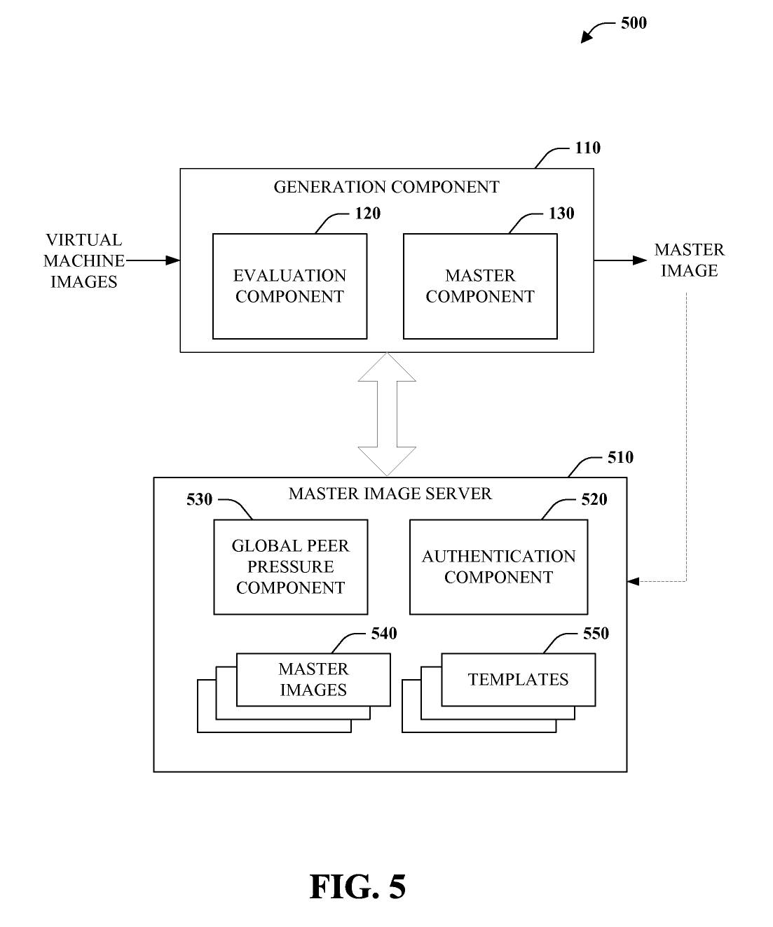

FIG. 5 illustrates a system 500 that facilitates creation and distribution of a master image. The system 500 includes the generation component 110 that constructs a master image with data segments that are common amongst virtual machine images. The master image is created to include as much shared data as possible from the virtual machine images, for example. With the use of a peer pressure technique, the master image includes data segment common in a majority of the virtual machine images or data segments that are influential within the virtual machine images. In other words, the master image can be considered to be a data highest common denominator for of virtual machine images.

The system 500 includes the generation component 110 that constructs a master image as discussed above. Moreover, the system 500 includes a master image server 510 (also referred to as MI server 510). The master image server 510 can be a local server or remote server in which clients can access master images 540 and/or virtual machine images. In general, the master image server 510 can be accessed by local clients and/or remote clients in order to upload, download, store, or view master images 540 and/or virtual machine images. By way of example and not limitation, the master image server 510 can be cloud-based and/or PaaS-based. Additionally, the master image server 510 allows access (with expressed permission from an owner) to master images 540 and/or virtual machine images from various users, clients, companies, and the like. Moreover, it is to be appreciated that for the sake of brevity, a single generation component 110 and/or master image is depicted in the system 500 but a plurality of master images, generation components, and/or clients (not shown) can access the master image server 510.

A master image created by the generation component 110 can be uploaded and stored to the master image server 510. It is to be appreciated that the master image server 510 can be an opt-in or opt-out service. Prior to accessing the master image server 510, an authentication component 520 employs security and authentication techniques. The authentication component 520 can utilize usernames, passwords, security question, cryptography, Human Interactive Proofs (HIPs), and the like. In general, the authentication component 520 provides a validated and secure connection for data communication. The authentication component 520 can further request permission to distribute and share any uploaded master images and/or virtual machine information.

The master image server 510 further includes a global peer pressure component 530. The global peer pressure component 530 expands the peer pressure technique discussed above in FIG. 2 by including additional sample sets (e.g., virtual machine images) in order to identify the common data segments amongst a majority of virtual machine images. Moreover, the global peer pressure technique can expand the sample set of virtual images to identify data segments common between virtual machine images that are influential. Thus, there can be a local peer pressure technique that employs a peer pressure technique using local virtual machine images as a sample set. Additionally, there can be a global peer pressure technique that utilizes a peer pressure technique using local virtual machine images and virtual machine images from the master image server 510 as a sample set. It is to be appreciated that the system 500 can provide a selection between a global peer pressure technique and a local peer pressure technique regardless of opting in or opting out of the master image server 510. In an example, the global peer pressure component 430 can evaluate the local virtual machine images to which a master image is to be created. Based on such evaluation, additional virtual machine images from the master image server 510 can be identified to include in the global peer pressure analysis, wherein the additional virtual machine images can include shared metrics, characteristics, and the like. In another example, the additional virtual machine images can be selected or identified within the master image server 510 by a user, a client, or an administrator.

As discussed briefly above, the master image server 510 can store master images 540 created from numerous virtual machine images and created from numerous virtual machine environments. The master images 540 can be viewed, transferred, downloaded, or the like. By way of example and not limitation, a master image can be downloaded and employed within a virtual machine environment. In particular, the master image can be invoked for a new or updated virtual machine. In another example, company A can create a master image 1 for a first set of virtual machine images and a master image 2 for a second set of machines, wherein the master image 1 and master image 2 are stored in the master image server 510. Additionally, company B can create a master image 3 for a set of virtual machine images in which the master image 3 is stored in the master image server 510. Following the above example, company B can leverage the master image 1 and/or the master image 2 in order to create a master image 4. Moreover, company B can invoke a global peer pressure technique that includes company B local virtual machine images but also company A virtual machine images (e.g., first set of virtual machine images and second set of virtual machine images).

Furthermore, the master image server 510 facilitates creation of a master image with the employment of a master image template 550 (also referred to as templates 550). The templates 550 can be a framework from which to create a master image for virtual machine images. The templates 550 can be based upon standardized characteristics for a particular virtual machine and/or virtual machine environment. For instance, a template for a master image can be business-based, company-based, or industry-based in which characteristics for the business, company and/or industry are identified and utilized to identify and include particular common data segments stored in a master image. In another example, a template can be based upon a type of operating system and/or process employed by the virtual machines. The templates 550 can be function-based in which a particular function includes characteristics to assist in identifying data segments to include in a master image. For example, a virtual machine environment related to accounting can create a master image for local virtual machine images based upon a template received from the master image server 510, wherein the template is an accounting-based template.

Referring to FIG. 6, a virtual machine image system 600 that facilitates virtual machine image transfer based on a created master image is illustrated. The virtual machine image system 600 utilizes a generation component 110 that creates a master image for streamlining virtual machine image transfers, migrations, storage, and the like. The virtual machine image system 600 can further include a migration component 610 that leverages the master image in order to facilitate migration of virtual machine images 410 for the creation of a new or upgraded virtual machine. By way of example and not limitation, the migration component 610 leverages the master image to create a new virtual machine in a virtual machine environment. For instance, the new virtual machine can be based upon a need for additional virtual machine based upon offline and runtime machine learning techniques. Moreover, the migration component 610 can employ the master image to upgrade or update a virtual machine, wherein the update or upgrade can include an updated master image, a portion of software, and the like. Moreover, the migration component 610 can utilize the master image for load-balancing within a virtual machine environment, scaling a virtual machine environment (e.g., scaling up-adding virtual machines/images, scaling down-reducing virtual machines/images, etc.), trouble-shooting a group of virtual machine images, and/or host computer load-balancing.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the generation component 110 or one or more sub-components thereof can employ such mechanisms to efficiently determine or otherwise infer a set of common data segments amongst virtual machine images in order to create a master image.

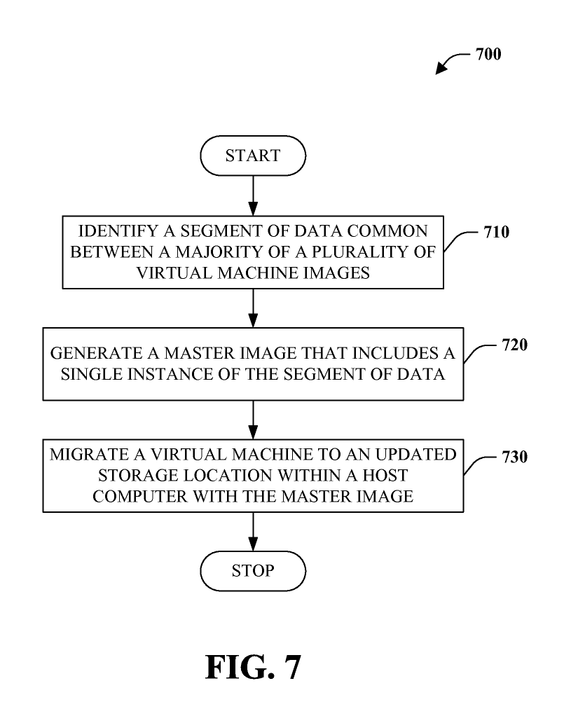

In view of the exemplary systems described supra, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 7, a method of generating a master image from a plurality of virtual machine images 700 is illustrated. At reference numeral 710, a segment of data common amongst a plurality of virtual machine images is identified. For example, a data segment common between two or more virtual machine images can be identified. In another example, a peer pressure technique (e.g., global peer pressure technique, local peer pressure technique, etc.) can be utilized in order to ascertain common data segments amongst a majority of the plurality of virtual machine images. At reference numeral 720, a master image is generated that includes a single instance of the segment of data. At reference numeral 730, a virtual machine is migrated with the master image to an updated storage location within a host computer. It is to be appreciated that the migration can include an update to a virtual machine or a creation of a new virtual machine.

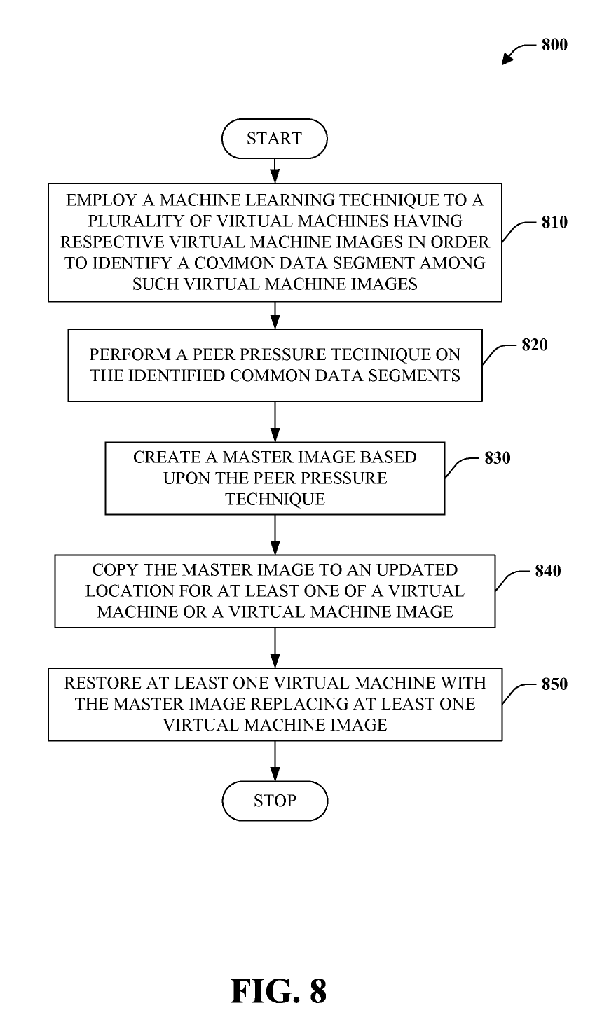

FIG. 8 is a flow chart diagram of a method 800 of migrating virtual machine image data using a master image. At reference numeral 810, a machine learning technique is employed to a plurality of virtual machines having respective virtual machine images in order to identify a common data segment among such virtual machine images. At reference numeral 820, a peer pressure technique is performed on the identified common data segments. It is to be appreciated that the peer pressure technique can identify common data segments amongst a majority of the virtual machine images in which the common data segments amongst the majority are included in the master image. Additionally, the peer pressure technique can identify a data segment that is influential amongst the virtual machine images, wherein the influential data segment is included in the master image. At reference numeral 830, a master image is created based upon the peer pressure technique. At reference numeral 840, the master image is copied to an updated location for at least one of a new virtual machine or an updated virtual machine. At reference numeral 850, at least one of the new virtual machine or the updated virtual machine is established.

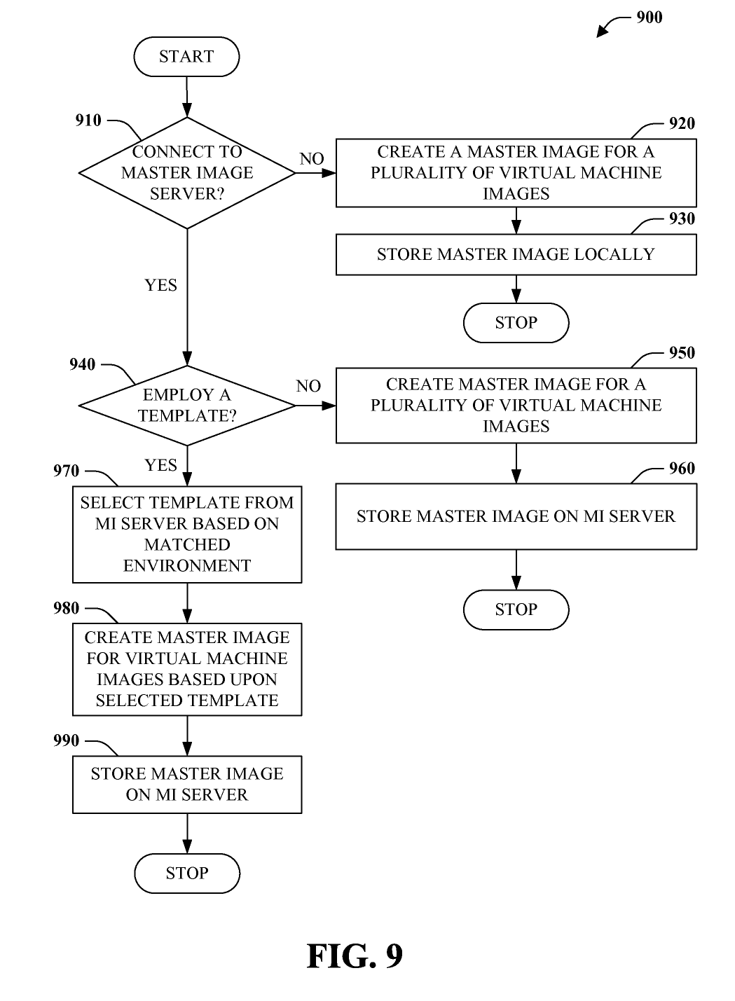

FIG. 9 is a flow chart diagram of a method 900 of accessing a server to create a master image for a plurality of virtual machine images. At reference numeral 910, a determination is made whether to connect to a master image (MI) server. If it is determined to not connect to the MI server (e.g., “NO”), the method 900 continues to reference numeral 920. At reference numeral 920, a master image for a plurality of virtual machine images is created. It is to be appreciated that the master image can be created based upon the techniques discussed above such as, but not limited to, peer pressure techniques, offline machine learning, runtime machine learning, priority techniques, and the like. At reference numeral 930, the master image is stored locally.

If it is determined to connect to the MI server (e.g., “YES”), the method 900 continues to reference numeral 940. At reference numeral 940, a determination is made whether to employ a template. If a template is not implemented (e.g., “NO”), the methodology 900 continues to reference numeral 950 in which a master image is created for a plurality of virtual machine images. It is to be appreciated that the master image can be created with a global peer pressure technique (e.g., global peer pressure technique includes leveraging the majority of common data for virtual machine images included within the MI server) or a local peer pressure technique (e.g., local peer pressure technique includes leveraging the majority of common data for virtual machine images included locally—not within the MI server). Continuing with reference numeral 960, the master image is stored on the MI server. By way of example and not limitation, the stored master image can be employed as a potential template, source of a template, re-used by another company/user, and the like.

If the determination is to employ a template (e.g., “YES”), the method 900 continues to reference numeral 970. At reference numeral 970, a template is selected from the MI server based upon a matched environment. For example, a matched environment can be user-selected, machine-matched, industry-based, and/or any combination thereof. The template can provide metrics and characteristics related to potential common data segments to collect in order to generate the master image. At reference numeral 980, a master image is created for virtual machine images based upon the selected template. As discussed above, the master image can be created with a global peer pressure technique or a local peer pressure technique. In another example, a user-defined combination can be implemented between a global peer pressure technique and a local peer pressure technique in which a portion of the global virtual machine images are selected for inclusion in a hybrid peer pressure technique. At reference numeral 990, the master image is stored on the MI server. By way of example and not limitation, the stored master image can be employed as a potential template, source of a template, re-used by another company/user, and the like.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

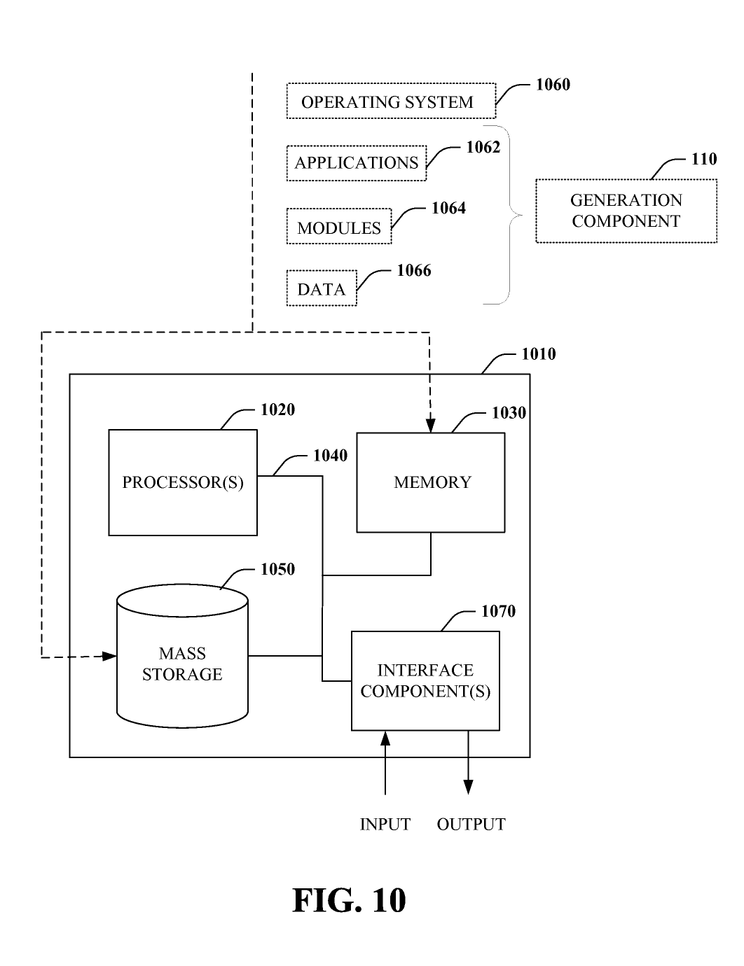

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer 1010 or computing device (e.g., desktop, laptop, server, hand-held, programmable consumer or industrial electronics, set-top box, game system . . . ). The computer 1010 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to memory 1030 that execute various computer executable actions, instructions, and or components.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the generation component 110 can be, or form part, of an application 1062, and include one or more modules 1064 and data 1066 stored in memory and/or mass storage 1050 whose functionality can be realized when executed by one or more processor(s) 1020, as shown.

In accordance with one particular embodiment, the processor(s) 1020 can correspond to a system-on-a-chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the generation component 110, and/or associated functionality can be embedded within hardware in a SOC architecture.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating management of virtual machine images, comprising:
employing at least one processor configured to execute computer-executable instructions stored in memory to perform the following acts:
identifying a data segment common between a plurality of virtual machine images; and
generating a master image that includes a single instance of the data segment.

2. The method of claim 1, migrating at least one of the plurality of virtual machine images based upon the master image.

3. The method of claim 1, migrating a virtual machine corresponding to at least one of the plurality of virtual machine images to an updated storage location with the master image.

4. The method of claim 1, employing a machine learning technique to at least one of the plurality of virtual machine images or at least one virtual machine associated with the plurality of virtual machine images.

5. The method of claim 4 further comprising:
invoking a first machine learning technique while at least one virtual machine associated with the plurality of virtual machine images is offline; and
invoking a second machine learning technique during runtime of at least one virtual machine associated with the plurality of virtual machine images.

6. The method of claim 4, employing the machine learning technique to identify the segment of data common amongst the plurality of virtual machine images.

7. The method of claim 1, performing a peer pressure technique to include common data segments that are found in a majority of the plurality of virtual machine images in the master image.

8. The method of claim 1, performing a peer pressure technique to include common data segments that are influential among the plurality of virtual machine images.

9. A system that facilitates creating master images, comprising:
a processor coupled to a memory, the processor configured to execute the following computer-executable components stored in the memory:
a first component configured to generate a master image from a plurality of virtual machine images, the master image includes a single instance of common data segments that reside within the plurality of virtual machine images.

10. The system of claim 9, further comprises a second component configured to evaluate the plurality of virtual machine images to identify data segments shared between the virtual machine images.

11. The system of claim 9 further comprises:
a third component configured to perform a peer pressure technique to ascertain which common data segments are within a majority of the plurality of virtual machine images; and
a fourth component configured to employ a machine learning technique to identify common data segments within the plurality of virtual machine images.

12. The system of claim 9 further comprises a fifth component configured to prioritize data segments related to the plurality of virtual machine images for inclusion within the master image.

13. The system of claim 12, the fifth component configured to prioritize data segments based upon at least one of a host virtual machine, a data size on virtual machine image, a size on a virtual hard drive (VHD), a data segment type, a host virtual machine location, a process-based, or an operating system association.

14. The system of claim 9 further comprises a sixth component configured to employ the master image to migrate at least one of the plurality of virtual machine images to an updated location.

15. The system of claim 14, the updated location is at least one of a new virtual machine, an updated virtual machine, a host computer, a remote host computer, a local computer, a virtual machine server, a remote server, a cloud, or a Platform as a Service (PaaS).

16. The system of claim 14, the sixth component configured to establish at least one of a new virtual machine or an updated virtual machine with the master image.

17. The system of claim 9 further comprises a master image server configured to store at least one of a master image, a virtual machine image, or at least one template to create a master image.

18. The system of claim 17 further comprises a seventh component configured to perform at least one of a global peer pressure technique or a local peer pressure technique, the local peer pressure technique utilizes locally stored virtual machine images as a sample set and the global peer pressure technique utilizes locally stored virtual machine images combined with virtual machine images from the master image server as a sample set.

19. The system of claim 17 further comprises an eighth component configured to authenticate a client accessing the master image server with at least one of a password, a username, a security question, or a human interactive proof (HIP).

20. A method of migrating virtual machine images, comprising:
employing at least one processor configured to execute computer-executable instructions stored in memory to perform the following acts:
employing a machine learning technique to a plurality of virtual machines having respective virtual machine images in order to identify a common data segment among such virtual machine images;
performing a peer pressure technique on the identified common data segments to ascertain common data segments stored on a majority of the virtual machine images; and
creating a master image based upon the peer pressure technique, the master image includes a single instance of the ascertained common data segments stored on the majority of the virtual machine images.
